(19) United States
(12) Patent Application Publication
(10) Pub. No.: US 2014/0018156 A1
(43) Pub. Date: Jan. 16, 2014

(54) REAL-TIME GAMING APPLICATION SOFTWARE AND APPARATUS

(71) Applicants: Patrick Rizzotti, Santa Monica, CA (US); Brett Forbes, Santa Monica, CA (US)

(72) Inventors: Patrick Rizzotti, Santa Monica, CA (US); Brett Forbes, Santa Monica, CA (US)

(21) Appl. No.: 13/547,680

(22) Filed: Jul. 12, 2012

(51) Int. Cl. A63F 13/12; A63F 13/00

(52) U.S. Cl. 463/25; 463/31; 463/42

(57) ABSTRACT

A real-time event-based gaming application is disclosed that allows players to compete against themselves or against one another during live sporting and entertainment events. The gaming application allows players to interact with other players and to predict one or more outcomes of upcoming plays, decisions, results, votes, or the like based on real-time odds by wagering points or money on various potential outcomes. Once the play, decision, result, vote or the like occurs, players' point totals are either credited or reduced based on the outcome and amount of the wager placed. Moreover, the gaming application may include a player interface for conveying information to a player and receiving information from the player, and a transceiver for exchanging data over a wireless network. Players may compete for prizes based on their performances in the gaming application.

### FIELD OF THE INVENTION

The present invention relates generally to interactive gaming applications. More specifically, the present invention relates to interactive gaming applications that involve real-time odds and that can be played simultaneously while viewing one or more live events in real time.

### BACKGROUND OF THE INVENTION

In the early 1970s, some of the first home video game consoles were released. The Magnavox Odyssey and the Atari Pong are several exemplary consoles from this era. Next came the Nintendo Entertainment System, Sega Genesis, PlayStation, and Nintendo64. More recent home video game consoles include Xbox 360, Play Station 3, and Nintendo Wii. Today, these and other gaming consoles are more prevalent than ever. Further, the categories of games that can be played on these gaming consoles are innumerable.

Nonetheless, one category of games that is prominent in gaming applications is sports games. At least one gaming application exists for virtually every sport known to man. More popular sports have hundreds if not thousands of associated video games that simulate everything from preseason games and practice to championship games and player trading. Some of these games may even incur updates based on actual player or team performance, trades, injuries, and so on.

Despite the abundance of sports-based gaming applications, none of these games provide a player with an opportunity to interact with a live game, let alone numerous live games, based on real-time odds of events occurring in the live games. A further limitation of the prior art games is that most gaming applications are not portable, as they require power from an electrical outlet and are designed to be played on home televisions or computers. Thus, a player must generally be stationed at home to play many of these sports games. And even then, interacting with live games is not an option.

Therefore, there is a long-felt need for a gaming application that—amongst other exemplary advantages set forth below—is portable and allows players to interact with one or more live events, such as sports games, either alone or with or against other players.

### SUMMARY OF THE INVENTION

The present invention concerns a real-time gaming application. The gaming application is intended to allow a “player” or “players” of the gaming application to compete alone or with one another during live events or “live” broadcasts, such as sporting events, involving professional or amateur athletes. Each player may earn or lose points depending on his or her performance during the live sporting events. The players may compete for a limited number of prizes. In the alternative, each player may wager real currency in the gaming application and thus earn or lose money.

In one embodiment, the gaming application may include a processor, memory, software, a player interface, a transceiver, a global positioning system (GPS), and a power source. The processor, which can be a general purpose or special purpose processor, may execute computer code in the software. The computer code of the software may be stored in the memory. The transceiver may transmit and receive data over a wireless network. The data may relate to a live sporting event, which may be a focal point of the game.

Further, by executing the computer code of the software and using the data received with the transceiver as input, the gaming application may convey information to the player through the player interface. The player interface may be a touch screen display, for example. The player interface may display various interfaces containing a multitude of output to the player. On the other hand, the player may also use the player interface to input data and compete in the game. Competing in the game may include guessing or predicting the outcome of a situation, play, series of plays or of the actual game itself. The game may involve wagering points or actual money based on real-time odds of potential outcomes. In general, the player's input will be based on the live event and/or the output shown on the player interface.

Other aspects of the gaming application may involve inviting friends and other contacts to participate in the game, sharing content with others via social media, and locating others nearby that are playing the same game. With regard to locating others, the gaming application may use the GPS for these purposes. Of course, players who do not wish to be contacted or located may modify their user settings accordingly.

Still further, the games contemplated by the gaming application are of a wide variety. The description below uses baseball as an example of a live sporting event. However, the gaming application in no way limits the live sporting events to baseball games. In fact, the gaming application contemplates games for virtually every sport. Likewise, a multitude of games may be available within each sport.

Another aspect of the disclosed gaming application is the capability to engage other players in alphanumeric chat, such as texting, for example. The gaming application facilitates one-on-one chats as well as group chats.

### BRIEF DESCRIPTION OF THE DRAWINGS

Further embodiments and aspects of the invention are indicated in the figures and in the remaining description. The invention will now be explained in a non-limiting manner by way of examples depicted in the drawings. In the exemplary drawings:

FIG. 1 is a schematic diagram of architecture that can be used in one embodiment of the gaming application.

FIG. 2 is a schematic diagram of a series of introduction interfaces for a gaming application.

FIG. 3 is a schematic diagram of a home menu interface for the gaming application.

FIG. 4 is a schematic diagram of a main game of the gaming application.

FIG. 5 is a schematic diagram of the main game based on one or more live sports games.

FIG. 6A is a schematic diagram of an aspect of the gaming application in which a player can locate other players playing the same gaming application.

FIG. 6B is a schematic diagram showing publicly-available details for another player.

FIG. 6C is a schematic diagram of an aspect of the gaming application in which a player can invite friends to play the gaming application.

FIG. 7 is a schematic diagram of an aspect of the gaming application in which a player can view details about a team's schedule or game, for example.

FIG. 8 is a schematic diagram of an aspect of the gaming application in which a player can view and edit his or her profile for the gaming application.

FIG. 9 is a schematic diagram showing the leaders of those playing the gaming application.

FIG. 10 is a schematic diagram of an aspect of the gaming application in which a player can view prizes associated with the gaming application.

FIG. 11 is a schematic diagram of various other aspects of the gaming application.

### DETAILED DESCRIPTION OF THE INVENTION

The disclosed game and gaming application may include both hardware and software components. These components allow the user to watch or view a live sporting or entertainment event and play along against oneself or against others, in some cases for prizes, in some cases for actual money. The user may also compete for other rewards such as frequent flyer miles, for example. The main objective of the game is to predict what will happen in the live event, before it occurs. If the user is located at the live event, the game can be played against others also at the event, but the game play is not so limited. Regardless of a location of the user, the user can choose to interact with other users playing the gaming application, whether via public chat rooms, private chat rooms, GPS capabilities, and so on, as described below.

A majority of the figures herein illustrate exemplary embodiments of various aspects of the software. The gaming application may carry out part of the present invention as software in the form of computer code. The term “computer code” may include, for example, programs, instructions, signals, source code, text, text files, machine code, executable files, various downloads, and/or data. The hardware, however, may be equally if not more important.

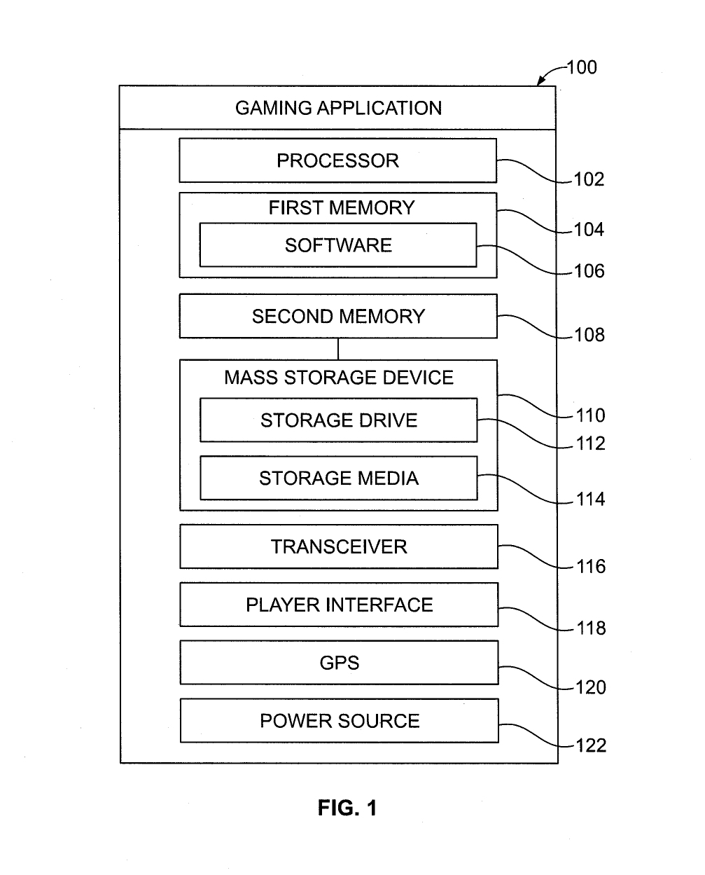

FIG. 1 of the present invention illustrates an exemplary embodiment of a gaming application 100. The components shown in FIG. 1 are primarily hardware components. The gaming application 100 may generally include a processor 102, a first memory 104, software 106, a second memory 108, a mass storage device 110, a storage drive 112, storage media 112, a transceiver 116, a player interface 118, a global positioning system (GPS) 120, and a power source 122.

The processor 102 of the gaming application 100 may be a special purpose processor for this particular embodiment or a general purpose processor, and functions to execute computer code of the software 106. Further, the gaming application 100 may include one or more memories, such as the first memory 104 and the second memory 108. It is contemplated that the first memory 104, the secondary memory 108, or a combination thereof may function as a computer usable storage medium to store and/or access computer code of the software 106. The first memory 104 and the second memory 208 may be, for example, random access memory (RAM), read-only memory (ROM), some other mass storage device, or any combination thereof.

The second memory 108 may be the mass storage device 110. In the alternative, the first memory 104 may be the mass storage device 110, and the mass storage device 110 may comprise the storage drive 112 and the storage media 114. The present disclosure contemplates that the storage media 114 may be removable from the storage drive 112 in some embodiments. The mass storage device 110 and operation thereof may involve the following exemplary types of technology: program cartridges and cartridge interfaces, removable memory chips (such as an EPROM, or PROM), associated sockets, analog or digital audio connections, digital video interfaces (“DVI”), video graphics adapters (“VGA”), musical instrument digital interfaces (“MIDI”), parallel connections, PS/2 connections, serial connections, universal serial bus connections (“USB”), IEEE1394 connections, PCMCIA slots and cards, SanDisk cards, data cords, Compact Disc Read-Only Memories (“CDROM”), ZIP storage devices, tape storage devices, magnetic storage devices, optical storage devices, Micro-Electro-Mechanical Systems (“MEMS”), nanotechnological storage devices, floppy storage devices, flash memory, hard disk drives, and the like.

One purely exemplary purpose of the mass storage device 110 and the storage media 114 is to allow data to be transferred to and/or from the gaming application 100. The mass storage device 110 and the storage media 114 also allow, for example, the gaming application 100 to be physically serviced, updated, and the like.

The gaming application 100 may further or alternatively include other ways for data to be exchanged with the gaming application 100, particularly in embodiments where the gaming application 100 is portable. For example, the transceiver 116 may provide wireless data transfer capabilities by serving as both a receiver and a transmitter for the gaming application 100. Data may be transmitted and received in the form of signals, which may be electronic, electromagnetic, optical, or other signals capable of being sent and/or received by the transceiver 116.

Moreover, the transceiver 116 may use a proprietary wireless protocol in some embodiments. Though in other embodiments, the transceiver 116 may use well-known wireless protocols, such as Bluetooth, WiFi, or Zigbee, for example. In still other embodiments, the transceiver 116 may use infrared signals or cellular communications. These wireless protocols may incorporate encryption techniques, especially where any form of personal information is transmitted or received. The transceiver 116 may exchange data over a local area network, over a wide area network, over a modem, over an intranet, over a cellular network, with other gaming applications, or with computers. In many embodiments, the transceiver 116 functions bi-directionally or omni-directionally.

A player may interact with and control the gaming application 100 through the player interface 118. The player interface 118 may include for example a display or touch screen display, a speaker, a vibrating mechanism, an alphanumeric keyboard, a touchpad, and/or general control buttons. The gaming application 100 may employ the display, speaker, and vibrating mechanism as output tools to convey information to the player. The player may use the keyboard, touchpad, touch screen display, and general control buttons, on the other hand, as input tools to convey information to the gaming application 100. Hence, due at least in part to the player interface 118, the gaming application 100 is interactive.

The gaming application 100 may further include the GPS 120. As described below, the player may choose to enable or disable the GPS 120 of the gaming application 100. If enabled, the GPS 120 may determine the position of the gaming application, or put another way, the position of the player. The gaming application 120, then, may allow other players to locate the player and, conversely, allow the player to locate other players within certain proximity, for example. This access to other nearby players greatly enhances the game play especially when the players are located at the live event or where the live event is being shown, such as a restaurant or bar. This is just one way in which players can chose to interact with one another. A position determined by the GPS 120 may be periodically stored, whether temporarily or permanently, in one or both of the first and second memories 104, 108. The software 106 may use this position as input for particular aspects of the software 106.

FIG. 1 is provided only for purposes of illustration, as are all the figures. The gaming application 100 is not limited to the specific embodiment shown in FIG. 1. For example, the gaming application 100 need not necessarily have each component shown in FIG. 1. In fact, the gaming application 100 may function properly using as few as one or two of the components shown in FIG. 1, as understood by one having skill in the art. The same goes for parts of the description where permissive language used. To illustrate, the player interface 118 may only have a touch screen display in some embodiments.

The gaming application 100 may use the hardware architecture described above to execute computer code of the software 106. The software 106 may be downloaded to the first memory 104 with the transceiver 116, or the software 106 may be installed in the first memory 104 before, after, or during assembly of the hardware.

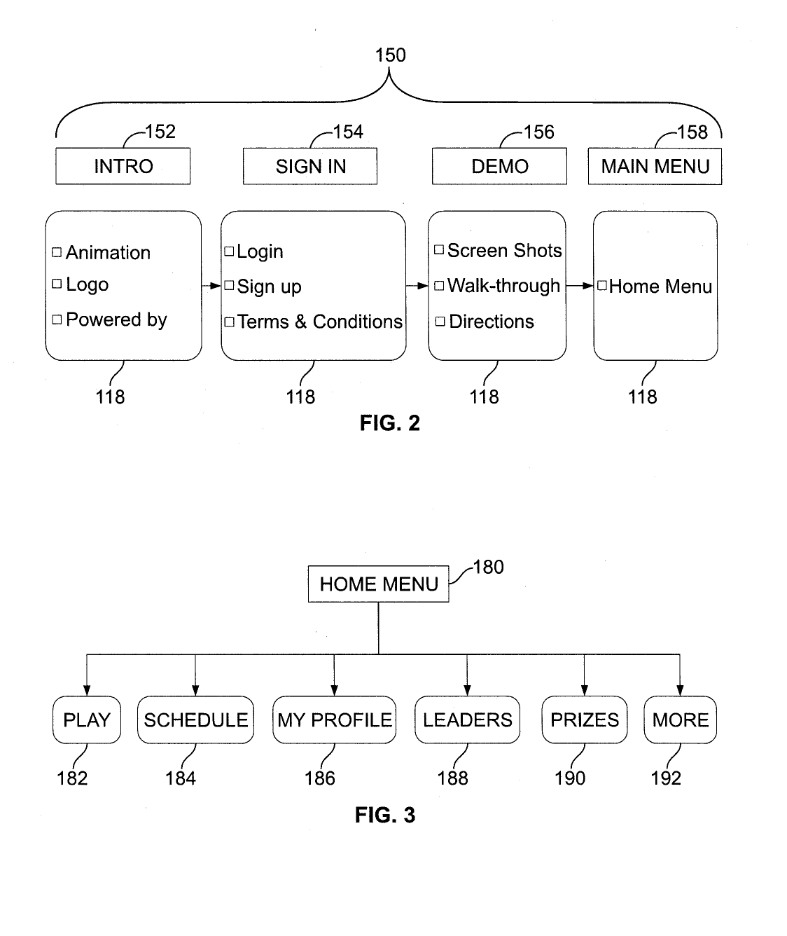

Turning to FIG. 2, a schematic diagram of a series of introduction interfaces 150 for the gaming application 100 are shown. The introduction interfaces 150 may be displayed sequentially on the display of the player interface 118. Specifically, the series of introduction interfaces 150 may include an initial introduction interface 152, a sign-in interface 154, a demonstration interface 156, and a main menu interface 158.

Some of the introduction interfaces 150, such as the initial introduction interface 152 and the main menu 158, for example, may be configured to display each time the gaming application is started. Other introduction interfaces 150, such as the sign-in interface 154 and the demonstration interface 156, for example, may only be configured to display at certain times. To illustrate, a player may configure settings within the gaming application to keep the player logged in so that he or she is not required to log in to the gaming application at the sign-in interface 152 upon each startup. In such an embodiment, the initial introduction interface 152 would lead directly into the main menu interface 158. The demonstration interface 156 can be configured similarly. For example, after the player uses the gaming application three times and hence becomes familiar with the gaming application, the gaming application may not run the demonstration interface 156 unless requested. In addition or in the alternative, the demonstration interface 156 may be configured to display only when a new player login is created.

In one embodiment, the introduction interface 152 may contain a brief animation, a logo, and an advertiser acknowledgment. The sign-in interface 154 may contain options to log in, to sign up for the gaming application, and to review and/or acknowledge terms and conditions of the gaming application. In embodiments where the gaming application is sold as a separate device, the sign up feature may not necessarily be present. In embodiments where the gaming application is incorporated into a cell phone, iPad, or other mobile device, the sign up feature may be appropriate.

The terms and conditions, moreover, may be placed on another one of the introduction interfaces 150, especially if a host of the gaming application desires for players to agree to the terms and conditions prior to each game. Further, the demonstration interface 156 may include directions and interface “screen shots” as part of a walk-through of how the software for the gaming application works. Further, the main menu interface 158 may provide an option to proceed to a home menu for the game aspect of the software.

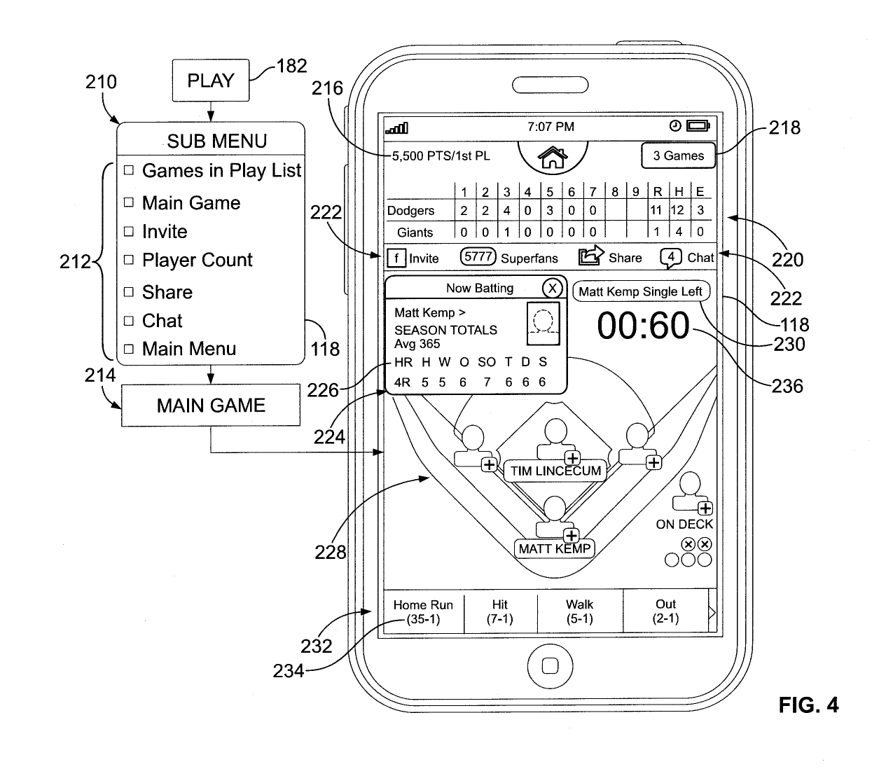

Once the player proceeds to a home menu interface 180, as shown in FIG. 3, a number of options may be presented to the player. For example and without limitation, the home menu interface 180 may provide options to play a main game 182, to view a team's schedule 184, to view the player's profile 186, to view leaderboards 188, to view prizes 190, and to view still more options 192.

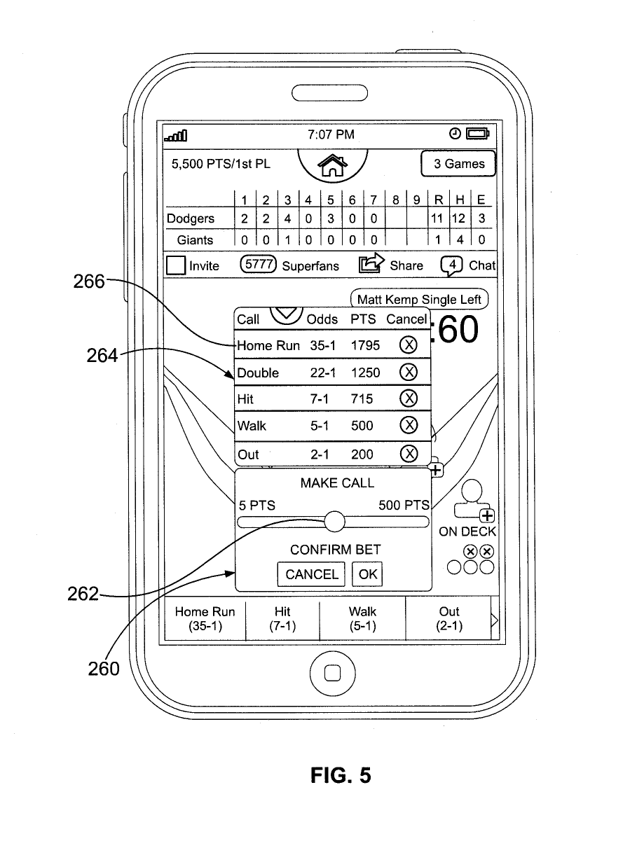

FIG. 4 shows a more detailed schematic view of one embodiment of the main game 182. Once the player chooses to play the main game 182, the player interface 118 may display a submenu 210. The submenu 210 may offer a number of options 212 related to the main game. By way of example, the options 212 may include listing the player's games in play, proceeding with the main game, inviting contacts or friends to play, displaying the number of players playing the gaming application, sharing via social media, chatting with other players, and returning to the main menu. In an alternative embodiment, choosing to play the main game 182 from the home menu 180 may cause a list of all current games in play to appear. A status for each game in play may also appear alongside the list of games in play.

Listing the player's games in play may show one or more games that the player is currently playing. The player may be playing three or four games at once, for example. As for inviting contacts or friends, this option may be populated with records from the player's phonebook stored on the first or second memories, especially in embodiments where the gaming application is incorporated into a cell phone. In the alternative, inviting others to play may provide the player with a list of “friends” from Facebook or some other social media site, with which the software may be programmed to communicate. In one embodiment, the number of players shown to be playing the game may be limited to a particular vicinity, such as within a half mile of a ballpark or venue at which the player is located, for example. In another embodiment, the number of players shown to be playing the game may be not be limited and may include every player anywhere that is playing the gaming application. These options 212 and others are further described below.

With continued reference to FIG. 4, the player may choose to proceed with playing the main game. The processor may then execute a specific portion of computer code from the software such that a main game interface 214 appears on the player interface 118. In this exemplary main game interface 214, the player's number of current points and rank 216 may be displayed. The current points and rank 216 may in some embodiments reset after each game. In other embodiments, the current points and rank 216 may be cumulative, per season or even the life of the player's use of the gaming application.

The main game interface 214 may also include a toggle button 218 by which the player may quickly jump between numerous games in play. As shown in FIG. 4, the player has three games in play. For example, depending on which game is selected, here the Dodgers versus the Giants, a scoreboard 220 may show the number of runs scored each inning, the number of hits, and the number errors. The toggle button 218 may in some embodiments flash or blink a particular color to notify the player that he or she has a certain amount of time (e.g., 20 seconds) to place a bet in another game. The player may have the ability to turn this type of notice on/off. Further, the notice feature may also operate in other views, such as where a games-in-play popover is showing three games, for example. The game in which a pending deadline to bet exists could flash or blink to notify the player of the deadline.

While the description and figures show the gaming application to be based on baseball, the gaming application is in no way limited to the sport of baseball. As described more below, baseball is merely an exemplary sport and is used only to facilitate a description of the present invention.

The main game interface 214 may provide popover buttons 222, shown here beneath the scoreboard 220. The popover buttons 222, similar to the options explained above in the submenu 210, may allow the player to invite friends to play the gaming application; to view the number of players (called “Superfans” of “SFs” in some embodiments) playing the gaming application based on a particular game, sport, location, and so on; to share thoughts, screen shots, or other information with other people; and to chat with others playing the gaming application or just friends in general. Selecting one of the popover buttons 222 may prompt the gaming application to present the player with a popup-like menu that is preferably positioned to the side or corner of the display of the player interface 118.

One example of a popover is a “Now Batting” popover 224. The Now Batting popover 224 may show key statistics 226 for the player at-bat. These key statistics 226 may include, for example, season batting average, home runs, hits, walks, and so on. Key statistics 226 may also be available to the player at times other than when the batter is batting. In general, the player may be able to access key statistics 226 at any time through a game overview screen, through a line up screen, and the like. Behind the Now Batting popover 224, a schematic 228 of the sporting event may be shown. The schematic 228 may depend on the game and sport being played. In a baseball game, the schematic 228 may show the identity of the pitcher and batter, the status of the bases occupied, who is “on deck,” and the balls-to-strikes count.

The main game interface 214 may further display the current batter's batting history 230 for the current game. This aspect and other aspects of the game are possible due to the gaming application use of the transceiver to constantly receive data from a wireless network in some embodiments. The gaming application may save this data, temporarily or permanently, in one of the first and second memories and allow the software to use this data as input. This data is not by any means limited to the current batter's batting history. The data may further include information relevant to the current state of the game, such as data for the scoreboard, the status of any base runners, and the like. In many embodiments, the gaming application will require real-time or near real-time data to allow the gaming application to stay current with the game, whether the player is watching on TV, at the stadium, listening to the radio, or somewhere else altogether.

In the exemplary baseball game shown in FIG. 4, the player may bet points based on his or her prediction of how the upcoming batter will perform. Thus, just prior to a batter stepping up to home plate for an at-bat, the player of the gaming application may wager bets on whether the batter will hit a single, hit a double, hit a triple, hit a home run, walk, make an out, or be hit by the pitch. The gaming application may allow the player to bet on how the batter will make the out. For example, the player could bet on whether the batter will pop out, groundout, or strikeout. In one embodiment, the player of the gaming application may bet whether a base runner will make an out, as opposed to the batter. Further granularity can also be part of the guess or prediction, including for example, whether the next pitch will be in or outside the strike zone, whether the batter will hit the ball out of the infield, etc. Bets 232 corresponding to these potential outcomes may be shown on the player interface 118. Directly underneath the bets 232, odds 234 of each bet 232 may be shown. The odds 234 may be real-time in that they can be continually recalculated based on the batter's performance up to the current game or even up through the current at-bat.

For example, if in the 8th inning of a baseball game a batter comes to the plate for his 401st at-bat and has 100 hits in his prior 400 at-bats current through this inning, the real-time odds of the batter getting a hit in his 401st at-bat may be 0.250, or 25%. Thus, the odds of the batter getting a hit, which can be shown to the user of the gaming application, would show as 1/4. In some embodiments, more precise or more realistic real-time odds may be available for purchase. As a further example, perhaps the batter is batting 0.500 in his last five games. Such information would be even further helpful to users of the gaming application. Thus, users may be able to purchase enhanced real-time odds for a given number of innings or the entire game, for instance. Other examples include factoring in batting statistics for home or away games, factoring in the weather, factoring in prior performance against a particular pitcher, and factoring in dimensions of the ballpark's field.

In other embodiments, though, the odds 234 corresponding to potential outcomes may be hidden from the player. There may be different levels of competition wherein more knowledgeable players choose to compete with others without the aid of the odds 234. This may present a further challenge for those most knowledgeable. Also, one skilled in the art will understand how the gaming application may truly be a game of skill, though the level of skill required to be successful may well vary depending on the embodiment.

Moreover, because the time between batters is limited, the gaming application may limit and show the amount of time 236 in which the player has to make as many bets as possible, as described more below. In some embodiments, this time may be the lesser of a fixed number of seconds, such as 60 seconds, and the point at which the pitcher begins his first windup for a batter. This time constraint may be imposed because it may not be practical to place additional bets during the often-limited number of seconds between pitches.

In other embodiments, however, especially where a fast wireless connection is available, it is conceivable that players could wager bets even between pitches. In such an embodiment, the wager on the previous pitch could either be annulled or maintained unless changed. These embodiments might add a further dynamic to the gaming application in that the real-time odds of each potential outcome change with every successive pitch.

It should be noted that in addition to or in the alternative to objects shown on the display 118, such as the amount of time 236 for betting, other objects may be shown. For example, a current-weather bar or performance-status bar may be shown on the display 118. In some embodiments, the player may customize the objects to be displayed according to his or her personal preferences.

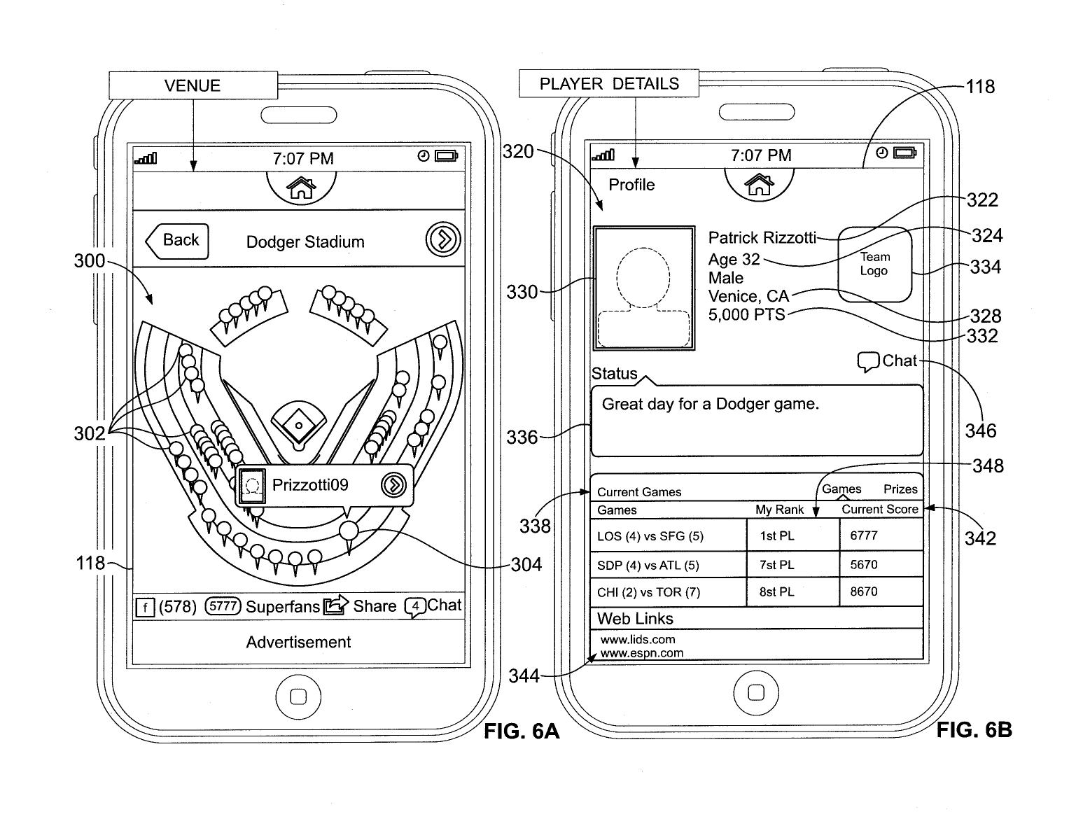

Once the player selects one of the bets 232 shown in FIG. 4, a “Make Call” popover 260 such as that shown in FIG. 5 may appear on the player interface 118. The player may then use a sliding scale 262 to wager a desired number of points on the selected bet. The sliding scale 262 may display a number of points (not shown) once the player starts translating the sliding scale 262. Once the number of points for that bet is chosen, the player may either cancel or confirm the bet. Upon cancellation or confirmation, a popover 264 showing a list 266 of the current bets may appear on the player interface 118. The current bets popover 264 may also provide an option to cancel each current bet. A minimize or hide button 268 may allow the player to return to the display shown in FIG. 4. In the alternative, the player may allow the current bets popover 264 to remain on the player interface 118.

As shown in FIG. 5, the player may place more than one bet for each batter. As with roulette and some other games of chance, the player may choose to wager more on outcomes with higher probabilities. Taking the example in FIG. 5, then, if the batter were to make an out, the gaming application would add 225 points to the player's score. Further, based on higher odds for particular situations, such as throwing a strike on a 3-0 pitch count, or a quarterback sneak on fourth and inches, the player may be limited as to how much can be wagered.

Although the preferred embodiment allows a player to guess or predict the next pitch or action, the present invention further contemplates allowing players to decide which event will occur next or before a given game time. For example, a player may guess that a goal will be scored in a hockey game before the next penalty. The real-time odds will change depending on the team statistics for scoring goals and being penalized. Another example allows for a player to guess or predict whether a golfer will birdie a hole before his or her next bogey. Further, whether a basketball team will score 25 or more points in the 3^{rd} quarter of a game. Again, the real-time odds are determined based on that team's scoring averages and the opposing team's defensive statistics.

Because the gaming application is played in real-time, the player may become particularly engaged in one or more sporting events. A further advantage of the gaming application is its convenience, as the player need not necessarily wager bets, in points or in real currency, for every batter. The player may wish to play only for a few innings, only for one team's batters, or only for a select few batters. The player may even enter preferences so that the gaming application uses the vibrating mechanism to notify the player shortly before the player's preferred batters are due at bat. The player could then respond to this “prompt” by wagering bets at appropriate times.

As each bet is placed, as each bet is won or lost, and so on, the transceiver of the gaming application may exchange data with the network. In other embodiments, the gaming application utilizes the transceiver as little as possible to preserve the power source, such as the power source 122 shown in FIG. 1. For example, the gaming application may store as much data as possible in the first or second memories and send this data after the game is finished. For example, this data may include the amount wagered on each at-bat or each pitch and the player's current score thereafter. In other words, the software, processor, and other components of the gaming application could compute the current score for the player after each wagered bet—without the player ever knowing that the results of the bets and hence current score were not sent until after the game. The transceiver may still need to receive data relevant to the status of the game in real-time or near real-time, but the power source would be preserved at least in part because the transceiver would not be transmitting unnecessarily. This may be particularly advantageous in embodiments where the gaming application is incorporated in a cell phone, as the power sources in cell phones typically provide limited resources.

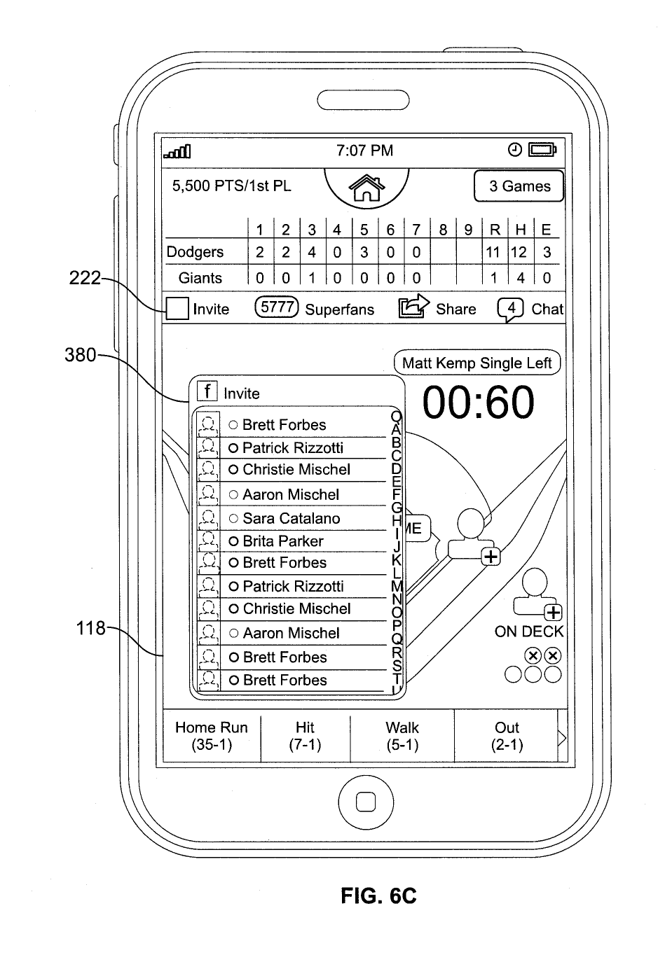

As shown in FIG. 6A, the GPS of the gaming application provides a further way for the player to interact with other players. If the player selects the Superfans or SFs button 222 as shown in FIG. 5, a popover may appear in which the player can view the locations of other players that have enabled the GPS feature through the gaming application. The popover may allow the player to select a radial distance in which to view the locations of other players.

The gaming application may take coordinates from the GPS and identify the location of the player. The gaming application may compare the coordinates to stadiums and locations known to accommodate sporting events. If the coordinates from the GPS sufficiently approximate the coordinates of those venues, the gaming application may display or give the player the option to display a map 300 of that venue. Other players that have enabled the GPS function on their gaming applications may show as markers 302 on the map 300. The player's own location 304 may be marked uniquely to distinguish it from other players' markers 302. The player can then tell where other players are located in relation to his or her location. If the player wishes to browse fellow players' publicly available details, the player may select one of the markers 302 to view that player's profile.

Once the marker 302 is selected, a profile 320 of the player associated with the location of that marker 302 may appear on the player interface 118, as shown in FIG. 6B. A user's profile, such as the profile 320 in FIG. 6B, may include a variety of information including name 322; age 324; gender 326; home city 328; any picture 330; current overall points 332; favorite team badge 334; status 336; current games 338, ranks 340, and scores 342; and web links 344, for example. All the while, the transceiver of the gaming application would be transmitting request signals and then receiving response signals representing the locations and profiles of other players. Of course, players may choose to share none of this information and to prevent anyone from locating them.

In the event that the player wishes to engage the other player shown in the profile 320 in chat, the player may select the chat button 346 shown on the profile 320. The player in the profile could then decline or accept the chat invitation. Moreover, profiles of players that do not wish to engage in any chat may not show the chat button 346. Yet the ability to identify specific individuals may be particularly advantageous where the player is at an away game, for example, looking to join up with fans of the same allegiance. As a further extension of this aspect of the invention, the gaming application may in some embodiments recommend certain players with like interests based on information in profiles.

Still another way to interact with others during the game is for the player to invite other contacts, friends, or acquaintances to play the game. FIG. 6C shows an example of a popover 380 pertaining to the Facebook invite button 222 shown here and in FIG. 4.

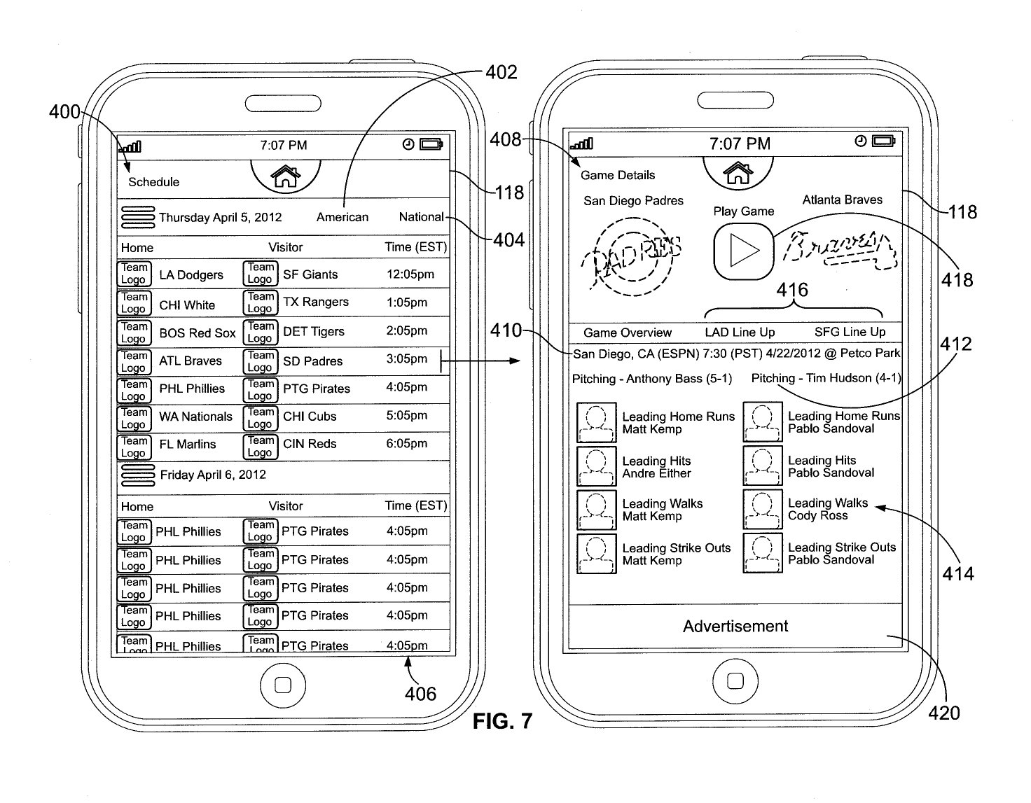

Referring back now to FIG. 3, the player may select a number of other options besides playing the main game 182. One option is for the player to select the schedule 184. Upon doing so, the gaming application may display on the player interface a schedule 400 as shown in FIG. 7. The schedule may allow the player to choose between an American League schedule 402, National League schedule 404, or a combined schedule (not shown). In some embodiments, the games on the schedule 400 may be arranged by date, with the schedule of games on any given date being collapsible. In other embodiments, the player may select and view a particular team's schedule for the next two weeks, for example. The schedules may also show times 406 of the games, a television network (not shown) if televised, and so on.

The gaming application may allow the player to select a particular game on the schedule 400. Further details 408 for that game may then be shown on the player interface 118. Additional information specific to that game may also be provided, such as a location and time of the game 410, starting pitchers 412, and team leaders 414. The further details 408 may also include buttons 416 to toggle to a home team lineup and an away team lineup. Also, the further details 408 may include a queue button 418 that puts the selected game in queue for the player. The gaming application may use the vibrating mechanism (not shown) of the player interface 118 to remind the player about the game shortly before the opening pitch.

The gaming application also contemplates using small portions of certain interfaces for advertising 420. Paying advertisers or advertisers that contribute prizes, as described below, may have their advertisements posted across small portions of interfaces of the gaming application. Further, the player may be able to order from that advertiser during the game, download coupons, access the advertiser's website, etc.

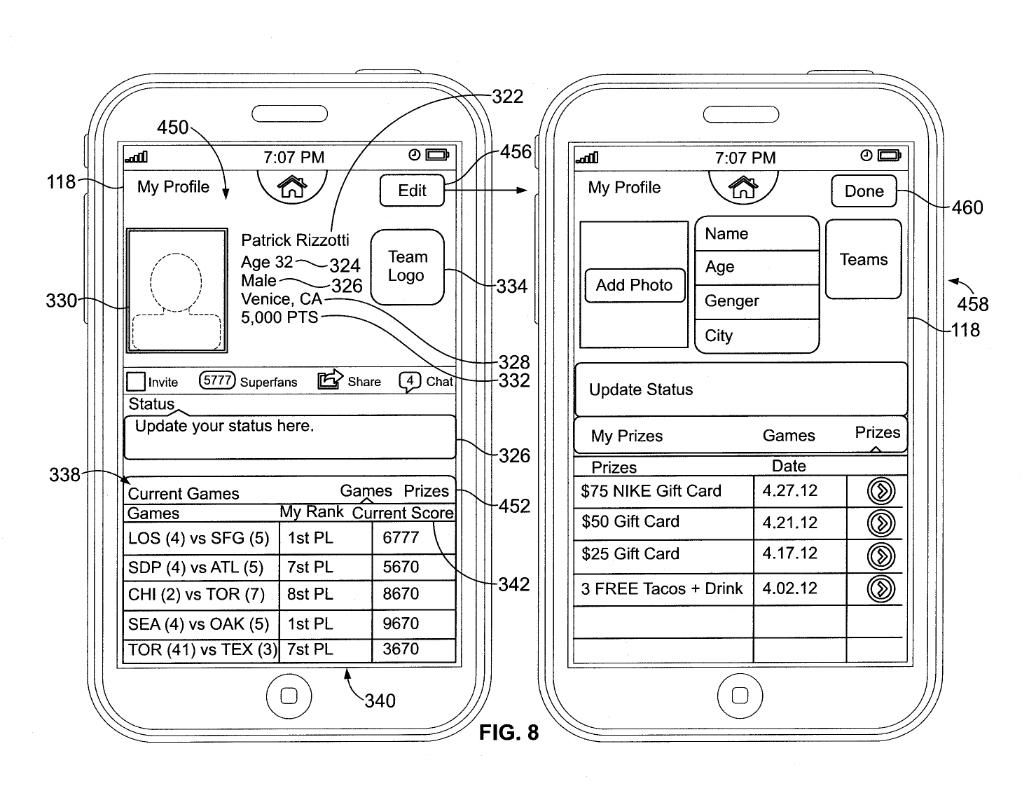

Referring now to FIG. 8, each player may have a customizable profile 450 that is navigable from the home menu 180 shown in FIG. 3. As explained above and as shown in FIG. 8, the customizable profile 450 may contain a variety of information including name 322; age 324; gender 326; home city 328; any picture 330; current overall points 332; favorite team badge 334; status 336; current games 338, ranks 340, and scores 342; web links (not shown); and prizes 452 and dates (not shown) of prizes 452, for example. By clicking an edit button 456 on the customizable profile 450, each player may input as much or as little information as he or she desires in a profile edit mode 458. Once that information is input, the player may exit out of the profile edit mode 458 by clicking a “done” button 460.

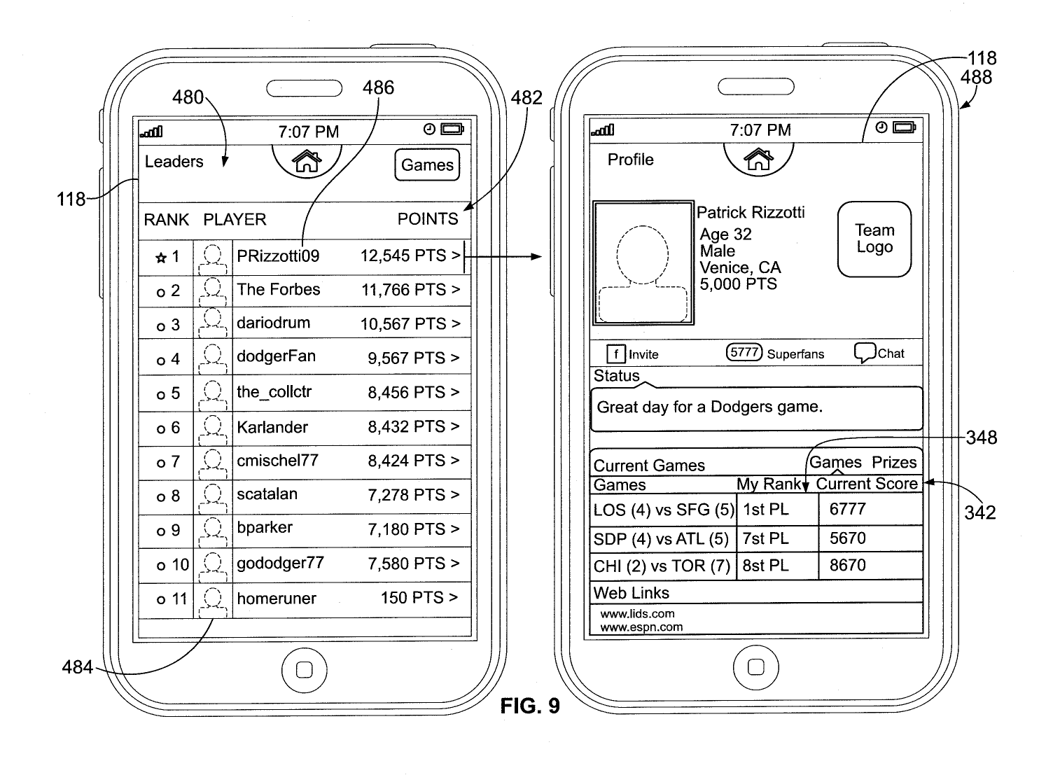

From the home menu 180 shown in FIG. 3, the player may also select the leaders 188 submenu. Doing so may cause the gaming application to display a leader board 480 on the player interface 118, as shown in FIG. 9. In one embodiment, the leader board 480 may pertain to all players using any form of the gaming application. In another embodiment, however, the leader board 480 may pertain to a particular subset of players, such as a league in which the player is playing, a particular sport, a particular group of fans (e.g., Seattle Mariner fans), and so on. The player may be able to switch between subsets in some embodiments. Leaders may be ranked by points 482, and the leader board 480 may also display a thumbnail 484 of a picture and a name 486 associated with each leader.

If the player is interested in viewing the profile of a certain player on the leader board 480, the player may select that player using the player interface 118. The player interface 118 may then display a leader profile frame 488 that shows all or a subset of publicly-available information from that leader's profile, such as that shown in and described with regard to FIGS. 6B and 8.

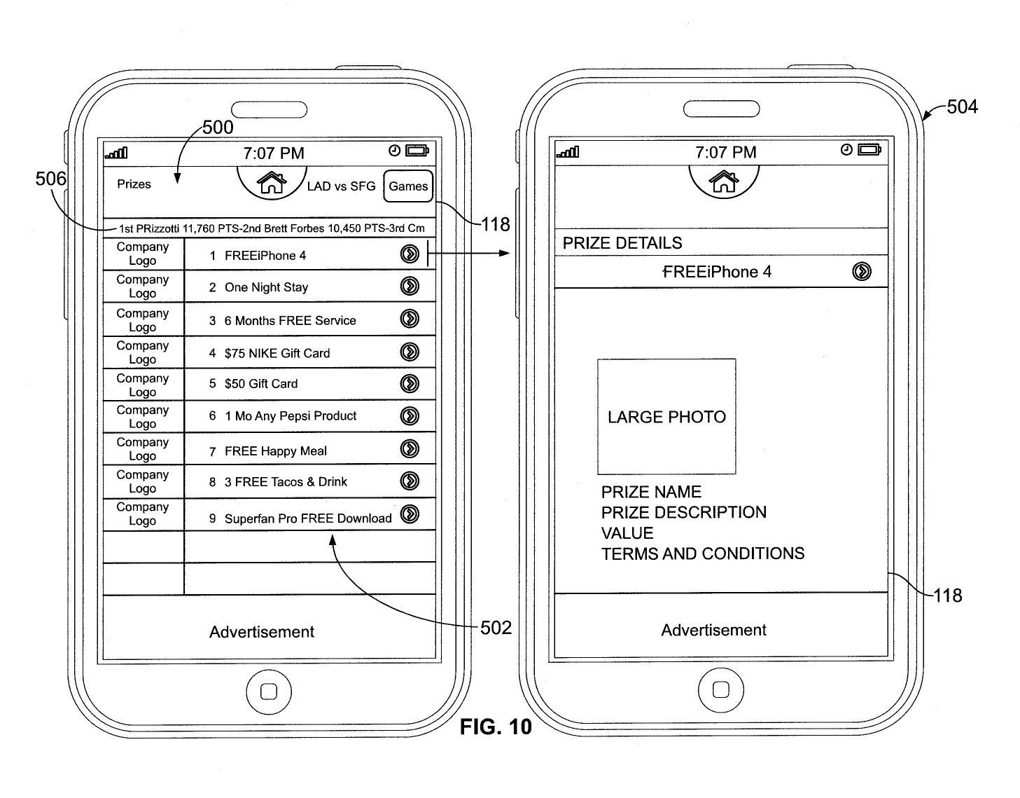

Still further, the player may navigate from the home menu 180 shown in FIG. 3 to the prizes 190 submenu shown in FIG. 10. Selecting the prizes 190 submenu may cause the gaming application to display a prize board 500 on the player interface 118. The prize board 500 may include a list 502 of prizes for which players are competing. The list 502 of prizes may be sorted by order of most to least desirable, for example. Further, details 504 for a particular prize may be viewed by selecting a prize from the list 502 of prizes. Further yet, a scroll bar 506 on the prize board 500 may display a rolling list of current leaders.

The gaming application may use a multitude of point and prize schemes. In one such exemplary scheme, players of the gaming application for a particular sport compete against one another. Every month, each player is allotted a given number of points. At the end of the month, the leaders for that month are awarded the prize corresponding to each leader's rank. In addition or in the alternative, grand prizes may be available based on competition that lasts the length of the actual sports season, including playoffs. These point and prize schemes are purely exemplary, and the present invention is in no way limited to these point and prize schemes.

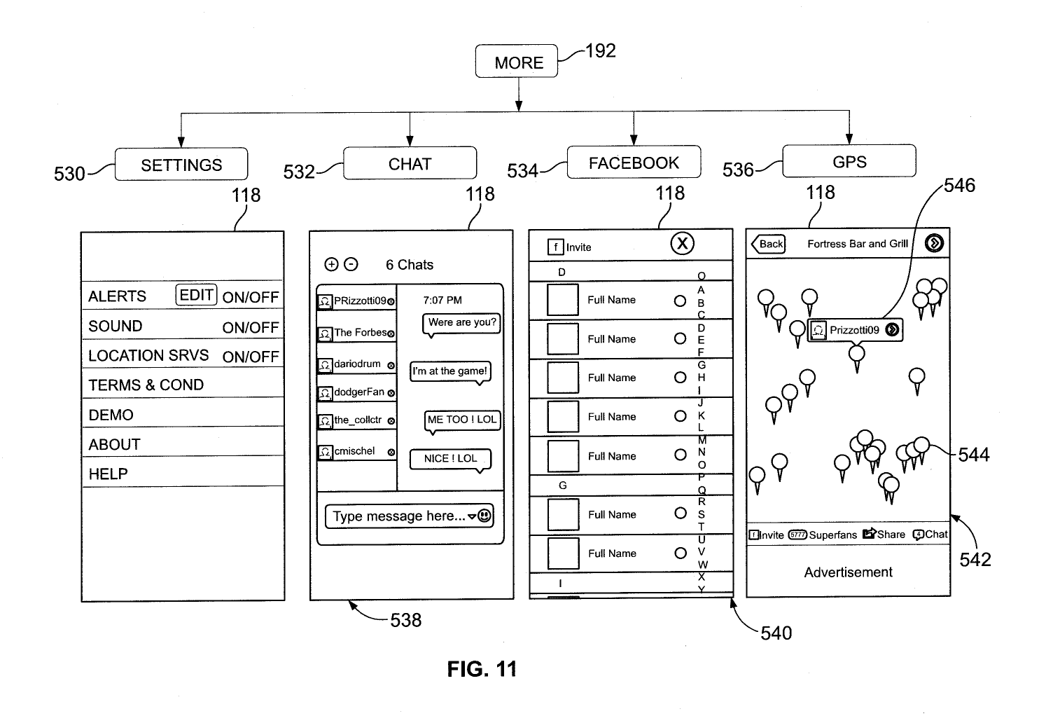

Players may navigate from the home menu 180 shown in FIG. 3 to the more 192 submenu shown in FIG. 11. The more 192 submenu may include further submenus, offering options for the player to adjust settings 530, participate in chat 532, open Facebook 534, or search for other players nearby 536.

The settings 530 may involve setting alerts for particular games, particular batters, and the like. Several exemplary settings 530 concern sound, GPS, terms and conditions, and demonstrations. Information and help regarding the gaming application may also be available. Another exemplary setting that is not shown may concern privacy settings.

In one embodiment, the chat menu 532 may open a full chat interface 538 that displays across the entire player interface 118. In another embodiment, the chat menu 532 may open a chat interface that is shown as a popover and does not consume the entire display of the player interface 118. The gaming application may include the capability to toggle back and forth between a full chat interface, such as the full chat interface 538, and a chat popover. This may be the case whether the chat feature was accessed from the main game or from the more 192 submenu. Further, the chat feature may facilitate one-on-one chats and group chats. Group chats may be particularly entertaining where players exchange banter or “talk trash” during a game. Character limitations may be imposed particularly for group chats.

Next, if the player selects the Facebook 534 option, the gaming application may display a full Facebook invite interface 540. In the alternative, the gaming application may open a typical Facebook homepage across the entire player interface 118. Still another alternative involves opening a Facebook invite interface in the form of a popover. In any case, the player may invite Facebook friends to participate in the gaming application or may utilize Facebook as one would typically through an Internet browser.

In addition, the option to search for other players nearby 536 may cause the gaming application to display a GPS interface 542 similar to that shown in FIG. 6A. Accordingly, the player can search nearby for other players that have the GPS feature of the gaming application enabled. The GPS interface 542 may show locations 544 of other players. Where the player selects one of the other players on the GPS interface 542, the gaming application may display a name 546 of the location where the other player is located. Further similar to the embodiment described with respect to FIG. 6A, the player may view publicly-available details about the other players based on their profiles and invite the other players to chat.

It should be noted that the baseball game described above represents only a fraction of the possible embodiments of the disclosed gaming application. The present invention contemplates many different types of baseball-based gaming applications. For example, another baseball-based gaming application may involve a pitcher-oriented game with an equivalent or comparable point and prize scheme. In one embodiment, the player could predict balls, strikes, and/or pitch speed. Still another example may involve a game where the player keeps official score of the baseball game. At the end of the game, the player's scorecard is compared to an official scorecard, and the player is awarded points based on the accuracy of the scorecard. The player input to the scorecard could be limited to one minute after each half inning, so that players could not cheat.

The present invention also contemplates many other real-time games that are based on a sporting event other than baseball. For example, in golf, players could bet on the golfer's score for a particular hole, the golfer's fairway percentage from the tee box, the number of putts, and so on. In hockey, players could bet on the number of checks by a team, the number of shots by a team, the number of goals by a team, the number of fights in a game, and so on. In NASCAR, players could bet on winners, finishing times, crashes, and so on. In football, players could bet on pass or run plays, on the length of a particular drive, on final scores, on field goals, and so on.

The present invention further contemplates embodiments wherein the gaming application allows users to compete with regard to non-sporting events, such as televised entertainment events. For example, whether the entertainment event is live or rebroadcasted, users could place bets on the winners of shows such as American Idol, Dancing with the Stars, the Oscars, the Grammy Awards, the Voice, and so on. Moreover, a “live event” or the like may also refer in some embodiments to a “live” broadcast—or first public broadcast—of entertainment or sporting events.

In all of these examples, real-time odds pertaining to probabilities in these events may be utilized along with providing users with the ability to interact with one another through chat, GPS locating capabilities, and the like. The present invention further contemplates the possibility of wagering money instead of points, but only where such wagering is legal. In some embodiments, for example, the gaming application may pull real-time odds from well known sportsbooks. Two examples of competitions on the gaming application where real-time odds can be collected from sportsbooks are the Kentucky Derby and March Madness. It should be noted, moreover, that the gaming application may also retrieve real-time odds from well known sportsbooks in embodiments wherein users are playing merely for points, not money.

In other embodiments, the disclosed gaming application may be compatible with fantasy sports platforms and tournaments. Users could partake in monetary gambling or fictitious point gambling. Further, users could invite their friends to play particular games where users draft players on a per game basis, for example. As described above, users can agree to compete for only certain portions of games. Still further, users may compete against each other in head-to-head competition, in group competition where invites or passwords are required, or in more “global” competitions where the general public competes. In some embodiments, the terms of these competitions, tournaments, and the like may be specified by the users competing. For example, ten friends competing with one another during a baseball game may agree in advance to wager ten dollars on the game. The winner may take the pool of one hundred dollars, or first, second, and third place may each receive a payout of the pool. On the other hand, the ten friends could also agree to wager one dollar per bet, for example.

In short, the possibilities are virtually endless, as the disclosed gaming application contemplates competitive games for virtually any sport and virtually any entertainment show.

The above description refers to both popovers and full screen interfaces. Popovers and full screen interfaces are largely interchangeable depending on the player's preferences. Moreover, for the purposes of the claims below and the description above, both popovers and full screen interfaces may be said to fall within the general category of interfaces.

The present invention as described herein is not limited to the above mentioned embodiments and exemplary working examples. Further developments, modifications, and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

1. A first gaming application apparatus for allowing a first player to predict the outcome of at least one live event, comprising:
a power source for providing power to the first gaming application apparatus;
a memory having software in the form of computer code stored therein;
a processor for executing the computer code of the software stored in the memory;
a transceiver for receiving data relating to at least one live event;
a first player interface for displaying output based on the data relating to the at least one live event, the first player interface also for receiving input from a first player relating to the at least one live event, and
a global positioning system (GPS) for determining the position of the first gaming application apparatus,
wherein executing the computer code of the software generates interfaces for display on the first player interface, the interfaces displayed on the first player interface allowing the first player to predict one or more outcomes of the at least one live event, wherein the GPS allows a second player playing a second gaming application apparatus to locate the position of the first gaming application apparatus, and wherein neither said first player nor said second player actively participate in said at least one live event.

2. (canceled)

3. The first gaming application apparatus of claim 1 wherein the data that the transceiver receives relates to positions of other players, the first player interface capable of displaying the relative positions of other players in relation to the position of the first gaming application apparatus.

4. The first gaming application apparatus of claim 3 further comprising a chat feature that allows the first player to alphanumerically chat with the other players.

5. The first gaming application apparatus of claim 1 wherein the first player interface prompts the first player to predict the one or more outcomes of the live event based on real-time odds, wherein the first player interface provides the first player with at least one way to interact with other players.

6. The first gaming application apparatus of claim 5 wherein the first player interface prompts the first player to wager an amount of points based on the one or more outcomes of the live event.

7. The first gaming application apparatus of claim 6 wherein the first player competes for prizes based on a point system, said point system based on said amount wagered.

8. A gaming application intended for a player to use to compete against a plurality of other players in a game based on a live event in real time, the gaming application comprising:
executable computer code storable on a mass storage device, the executable computer code corresponding at least in part to the game based on the live event in real time;
input based on the live event in real time received by a transceiver from a network, the input usable with the executable computer code;
an interface generated from the executable computer code and the input received from the network, the interface providing capability for the player to compete against other players based on the live event in real time; and
a global positioning system (GPS) for determining the position of the gaming application, wherein the GPS allows the other players to locate the position of the gaming application, and wherein neither said player nor said other players actively participate in said live event.

9. The gaming application of claim 8 wherein the executable computer code is executed by a special purpose processor.

10. The gaming application of claim 8 further comprising a player interface for displaying to the player and receiving input from the player relating to the live event in real time.

11. (canceled)

12. The gaming application of claim 10 wherein the interface prompts the player to predict the outcome of upcoming plays in the live event in real time.

13. The gaming application of claim 12 wherein the interface prompts the player to wager an amount of points based on the outcome of the upcoming play in the live event in real time.

14. The gaming application of claim 13 further comprising a cell phone, wherein the cell phone comprises the mass storage device, the transceiver, and the player interface.

15. The gaming application of claim 14 wherein the cell phone further comprises a processor for executing the executable computer code.

16. A gaming application comprising:
a power source for providing power to the gaming application;
a memory having computer code stored therein;
a special purpose processor for executing the computer code stored in the memory;
a transceiver for receiving data relating to at least one live sporting event;
a player interface for displaying output based on the data relating to a live event in real time, the player interface for receiving input from a player relating to the live event in real time, wherein the player interface provides the capabilities for the player to invite other players to play; and
a global positioning system (GPS) for determining the position of the gaming application, wherein the interface provides a relative map of the position of the gaming application in relation to the positions of the other players;
wherein executing the computer code with the special purpose processor generates an interface for display on the player interface, the interface displayed on the player interface allowing the player to compete against other players in a game played simultaneously with the live event in real time, and wherein neither said player nor said other players actively participate in said live event.

17. The gaming application of claim 16 wherein the game involves the player betting on the outcome of an upcoming play in the live event in real time, wherein the data that the transceiver receives includes odds for each of the potential outcomes.

18. The gaming application of claim 16 wherein the live event in real time involves a Major League Baseball game, wherein the player interface allows the player to bet on more than one of the outcomes at a time.

19. The gaming application of claim 16 wherein the at least one interface provides the capabilities for the player to invite other players to play, for the player to view leader boards, and for the player to invite the other players to alphanumerically chat.

20. (canceled)
